(19) United States
(12) Patent Application Publication
(10) Pub. No.: US 2014/0214570 A1
(43) Pub. Date: Jul. 31, 2014

(54) METHOD AND SYSTEM FOR CONTENT SUBMISSION CONTINUATION

(71) Applicant: BAZAARVOICE, INC., Austin, TX (US)

(72) Inventor: Maksim Borisovich Smolev, Manchaca, TX (US)

(73) Assignee: Bazaarvoice, Inc., Austin, TX (US)

(21) Appl. No.: 13/750,543

(22) Filed: Jan. 25, 2013

(51) Int. Cl. G06Q 30/02

(52) U.S. Cl. CPC G06Q 30/0282
USPC 705/21

(57) ABSTRACT

Techniques for collection of user-generated content, such as reviews and/or ratings relating to products, are described. User-generated content relating to an opinion of a product may be received at a first location, such as a point of sale of the product (e.g., content may be collected by a device at a store). A record corresponding to the received user-generated content may be stored, and a reference that is usable to provide access from a second location (e.g., from computer system at a consumer's home) to modify the stored record may be provided. The provided reference may be usable by a consumer to submit additional information to the initially-submitted content and/or to revise the originally-submitted information. Authenticity-screening rules may be employed to mitigate opportunities for submission of fraudulent reviews.

### TECHNICAL FIELD

This disclosure relates generally to collection of user-generated content, such as user reviews. More particularly, this disclosure relates to techniques that may be used for enabling submission of a first portion of user-generated content (e.g., a real-time user review that is submitted at a store) and subsequent submission of additional related information (e.g., additional information submitted by the user from a different location).

### BACKGROUND

Many factors may influence a consumer's product-purchasing behavior. For example, various factors such as packaging, product color, and/or product placement within a store can influence the consumer's purchasing behavior.

One effective way to influence a consumer's purchasing behavior may include providing the consumer with word-of-mouth recommendations, such as peer reviews. For example, another person's experience with a particular product (e.g., good and/or service) may provide information that a potential purchaser considers valuable. For example, consumers may rely on reviews of movies, books, auto repair services, apartments, and restaurants prior to making purchases.

### BRIEF DESCRIPTION OF THE DRAWINGS

The drawings accompanying and forming part of this specification are included to depict certain aspects of the present disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features.

FIG. 1 depicts a diagrammatic representation of one embodiment of an architecture for submitting user-generated content, such as a user review.

FIG. 2 depicts a flow diagram of one embodiment of a method for submitting user-generated content.

FIG. 3 depicts an example diagram of one embodiment a process for submitting user-generated content through a user submission device.

FIG. 4 is a diagram illustrating one embodiment of a computer-readable storage medium.

FIG. 5 is a diagram illustrating one embodiment of an exemplary computer system.

### DETAILED DESCRIPTION

Conventional techniques for gathering user-generated content, such as user reviews, have often been directed to online environments. In marketplaces outside of an online setting, conventional techniques may provide a consumer with an invitation (e.g., printed on their receipt during checkout at a store) to complete an online survey or to call a telephone number to provide a review and rating of their shopping and/or product experience. Embodiments of the present disclosure may provide improved opportunities for collection of user-generated content by facilitating the initial collection of user-generated content at a point of sale (e.g., collecting user-generated content at a store at a time when some consumers may be more motivated to submit content), while also providing opportunities to continue the submission (e.g., by adding or appending additional user-generated content, by editing previously-submitted content) at a different time and/or place (e.g., at a time (place) when (where) some consumers may be more motivated to put forth additional effort to author more-detailed content).

The disclosure and various features and advantageous details thereof are explained more fully with reference to the exemplary, and therefore non-limiting, embodiments illustrated in the accompanying drawings and detailed in the following description. Descriptions of known programming techniques, computer software, hardware, operating platforms and protocols may be omitted so as not to unnecessarily obscure the disclosure in detail. It should be understood, however, that the detailed description and the specific examples, while indicating the preferred embodiments, are given by way of illustration only and not by way of limitation. Various substitutions, modifications, additions and/or rearrangements within the spirit and/or scope of the underlying inventive concept will become apparent to those skilled in the art from this disclosure.

Embodiments disclosed herein may provide techniques to enable users, such as consumers, to enter user-generated content (e.g., a review of a product) during an engagement at a first location (e.g., a store), and to later supplement that content with additional information. For example, a consumer shopping or browsing at a store for a particular product may be willing to provide a brief review of that product while the consumer is at the store. Similarly, a consumer shopping for a particular product at a store may encounter other products to which the consumer has an interest (e.g., other recently-purchased products to which the consumer has a strong sentiment), and may be inclined to provide a brief rating or review for those other products of interest while the consumer is at the store. At a later time (e.g., after returning home), the consumer may be willing to spend additional time to provide more-detailed data to supplement (e.g., by adding appending additional user-generated content, by editing previously-submitted content) the previously-entered brief rating or review that was previously submitted at the store by the consumer. To this end, embodiments of the present disclosure may provide a consumer with a means to quickly submit content (e.g., a review) relating to a product at a first location (e.g., a store) in a manner that requires minimal time. The consumer may be provided with a means to subsequently enter additional information to supplement the submitted content at a time and/or place that is more convenient to the consumer.

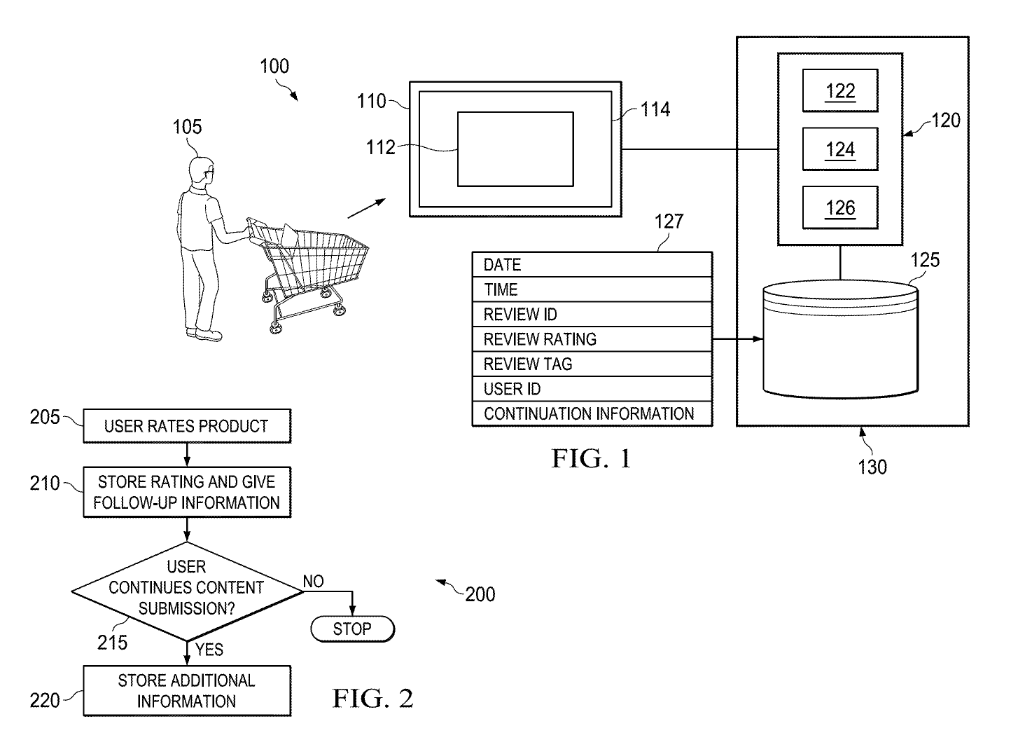

FIG. 1 depicts a diagrammatic representation of one embodiment of architecture 100 for providing for user-submission of content. In this example, consumer 105 may be at a store, shop, marketplace, or any location in which consumer 105 may browse or shop for certain items. The consumer may be presented with device 110 that allows the user to enter user-generated content, such as a review, using user interface 112. Device 110 may be referred to as an in-location content submission device. In one embodiment, device 110 may be a touch-screen computer device configured for receiving user-submitted information. More generally, device 110 may be any suitable device for capturing user input. Examples of suitable devices may include, but are not limited to, smart phones, computer terminals, computer kiosks, tablet computers, other internet-enabled devices, etc. In one embodiment, device 110 may comprise or may be coupled to a built-in printer. Device 110 may in some cases be installed at a physical location that is near a particular product (or group of products) that is the subject of user reviews.

Interactive user interface 112 may be provided using client software 114 running on device 110. In one embodiment, client software 114 may be web-based. In one embodiment, interactive user interface 112 may provide an opportunity for a user to enter free-form text, to provide a ranking, or to provide other indications of product sentiment (e.g., reviews, questions, answers, remarks, stories, ratings). Interactive user interface 112 may in some cases be tailored for an individual store, marketplace, or product category, and may vary from implementation to implementation. Interactive user interface 112 may prompt consumer 105 to rate a product and may provide consumer 105 with a user ID, nickname, or other reference for the review. In various embodiments, consumer 105 may not be required to provide personal information in order to obtain the user ID, thus protecting consumer privacy and encouraging consumers to provide frank, genuine reviews. Some embodiments of interactive user interface 112 may be configured to allow consumer 105 to enter a brief, simple review as an anonymous reviewer.

Client software 114 may in various embodiments be configured to operate on various operating systems. For example, embodiments of client software 114 may be configured for operating with LINUX, WINDOWS, MAC OS, and/or other operating systems. In some embodiments, device 110 may be communicatively connected to server 130. In some embodiments, server 130 may comprise content submission continuation component 120 having modules 122, 124 and 126. Each of modules 122, 124 and 126 may in some cases be configured to communicate with client software 114 running on a particular platform. For example, modules 122, 124 and 126 may be respectively configured for LINUX, WINDOWS, MAC OS, and/or operating systems. Component 120 may in some embodiments be communicatively connected to data repository 125 for storing content submitted by consumer 105.

In some embodiments, data repository 125 may additionally or alternately store other information related to content collected using device 110. For example, data repository 125 may store data such as table 127, which may include one or more of: date and time of submission, content ID (e.g., review ID), review rating, content tag (e.g., review tag), user ID, one or more portions of continuation information, and/or other information.

A review rating may be one particular rating for one particular product that is submitted by a reviewer. The rating may be based on different scales according to the needs and preferences of the particular client (e.g., a seller such as a wholesaler or retailer, a supplier such as a distributor or manufacturer) associated with device 110. For example, a rating may refer to a consumer's rating of a product on a scale of 1 to 10, on a scale of one to five stars, or some other method of expressing and conveying a consumer's sentiment.

A review tag may include additional data that may useful to associate with the content of a specific submission. For example, a review tag may include a descriptive word (or words) associated with a good, service, or brand that is a subject of a review, and may be useful for categorizing, searching, and/or otherwise processing the content of the review (e.g., “cleaning supplies” may be a tag used for identifying and categorizing cleaning product-related content).

A review ID may be one specific ID associated with one review by a consumer. In one embodiment, a review ID may be used only once, and may be subsequently stored in database 125 and disabled for further use. In other embodiments, a single review ID may be reused for one or more other submissions by the consumer.

In some embodiments, table 127 may contain additional information such as, for example, a store ID, store location, or product name (not shown).

Table 127, or other data structures that may be stored in data repository 125, may be configured to store continuation content (e.g., additional subsequently-submitted information, edits to initially-submitted content), that is associated with an initial content submission (e.g., content previously submitted at a device in a store by a consumer). In one embodiment, the continuation content may be a continued consumer review. For example, a consumer may create a brief initial review of a product while at a store by using one embodiment of device 110, and at a subsequent time choose to continue the review from a different location, such as from a computer at the consumer's home. Device 110 may in some embodiments facilitate later submission of the continuation content (and association of the continuation content to the initial content submission) by providing the consumer with a reference that is usable to access the initial content submission (e.g., a printed review ID, QR code or other bar code, mobile device-readable visual code, transaction number, and/or a Uniform Resource Locator (URL) associated with the initial review). Such a reference may in some embodiments be usable to access a content submission page (e.g., a page hosted by server 130) to facilitate submission of the continuation content. In some embodiments, server 130 may receive the initial review data from device 110 in real-time. Some embodiments may include server 130 receiving the initial review data from device 110 at a predetermined time. In some embodiments, server 130 may process and store the content submission information in data repository 125, as described above. In some embodiments, a consumer may use the review ID to access a content submission page that provides the initial content submission, thereby enabling the consumer to revise the initial content submission by adding continuation content and/or deleting/revising portions of the initial content submission.

In some embodiments, the reference that is usable to access the initial content submission may include a Quick Response code (QR code) or other machine-readable optical representation that is associated with a review ID. The consumer may use the QR code (e.g., by scanning using a device such as a smart phone) to access the content submission page to add to and/or modify the initial content submission. The content submission page may be presented to the user through a browser or native application running on the user device. The content submission page may comprise a form with certain fields that may be prepopulated with information collected at device 110, where the form may allow the consumer to provide additional information for a particular product. For example, the content submission page may be pre-populated with rating information submitted by the consumer using device 110 at a store, and the consumer may use a content submission page to add additional review information and/or to update the previously-submitted rating information.

Some embodiments may employ a reference in a form other than a machine-readable optical representation, where the reference is usable to access the initial content submission. For example, printed directions may instruct a consumer to access the initial content submission by, for example, accessing a URL and/or entering identifying information such as a transaction ID. Some embodiments may provide the reference to the consumer via electronic messaging techniques (e.g., text messaging, email, application-specific notification).

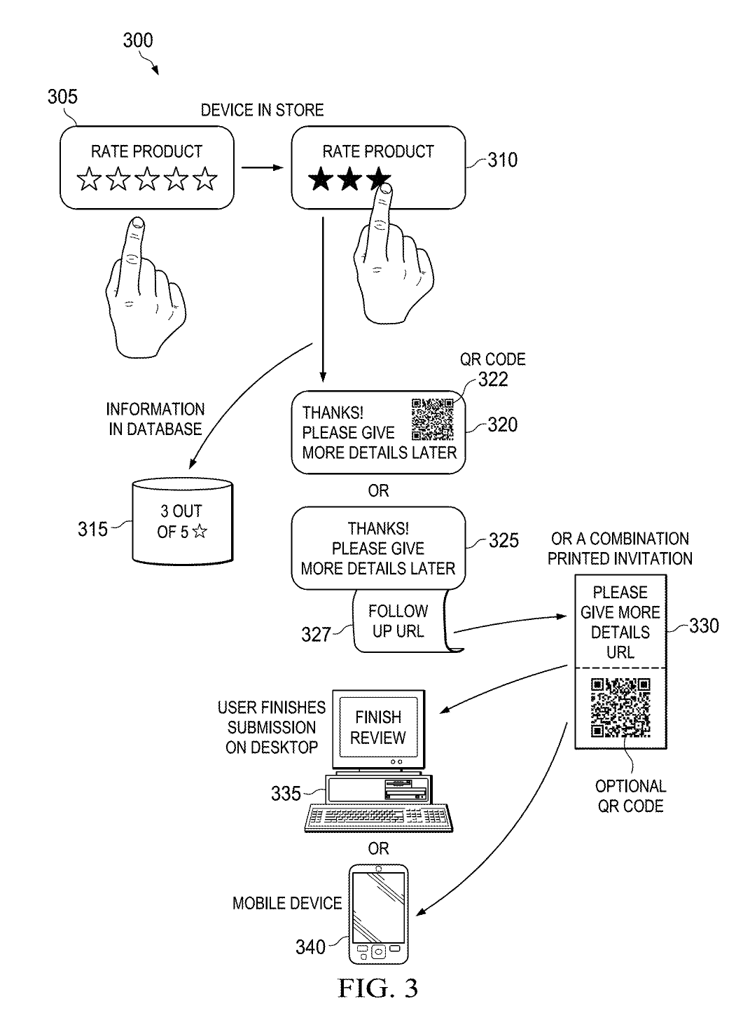

FIG. 2 depicts a flow diagram 200 exemplifying one embodiment of a method of content submission continuation. In this example, a consumer may rate a product (element 205) at a first location (e.g., store, showroom, or other retail or business establishment where the product may be purchased or browsed) through, for example, a few simple questions displayed on a content submission continuation device. In some cases, the content submission devices may be may be positioned near a product or marketing display in order to encourage the submission of content relating to the product (e.g., user-generated content relating to a good, service, and/or brand). At step 210, user-generated content, such as answers to these few simple questions, may be stored locally at the content submission continuation device and/or communicated (e.g., in real time, at a predetermined time, at a time when connectivity is available) to a server machine for possible further processing and storage. The content submission continuation device may be configured to provide the consumer with an option to continue the content submission at a later time that may be more convenient to the consumer. At step 215, the content submission process may continue or terminate, based upon whether the consumer chooses to continue with the submission of additional content. If the consumer chooses to continue the content submission (e.g., by completing the review and/or submitting a follow-up review), additional information may be collected via a user device and stored (step 220). Storage of the additional information may in some cases include transmitting data to a server for storage (e.g., in database 125). Alternately, in cases where the consumer chooses not to continue the content submission, information collection may cease. A more detailed overview of these exemplary steps is discussed below with reference to FIG. 3.

FIG. 3 depicts example process 300 for collecting an initial content submission, and for collecting a continued content submission. In this example, a consumer that is shopping in a store for a particular item may find a data collection device that displays information (element 305) prompting the consumer to enter content submission that is a rating or review for the particular item. In some implementations, the data collection device may be located near the display location of the particular item. The data collection device may in various embodiments include a touch-screen, push buttons, a keyboard, and/or various other input mechanisms to enable a user to submit information. In some embodiments, the consumer may begin the review process without being required to first login into an account. As part of the review, the consumer may provide (element 310) a rating for the product, such as for example by using the data collection device to give the product a rating of three out of five stars as shown in FIG. 3 (e.g., by touching the stars on a touch-screen device or pushing a button corresponding to a desired star rating on a push-button device).

In one embodiment, consumer-entered review and rating information corresponding to the consumer's content submission may be stored (element 315) in data repository 125 (e.g., in real time or substantially real time over a network connection). In this way, the consumer may subsequently be provided with access to the in-store review and rating, thereby facilitating the consumer's subsequent continuation (e.g., submission of additional content, revision of previously-submitted content) of the review and rating submission at a later time. In one embodiment, the consumer's review and rating information may be stored locally, communicated over a network connection to remote server 130, and stored in data repository 125. In one embodiment, the content submission device may not store any of the consumer's rating information locally.

In addition to the storing the consumer's review and rating information for a particular product, additional information may also be stored (element 315) in response to submission of an in-store review. For example, submission date, submission time, review ID, user ID, store-related information, and/or location-related data may be stored in table 127 residing in data repository 125.

Location-related data may be useful for giving retailers and/or suppliers geo-specific data on consumer behavior. For example, a particular higher-priced, environmentally-friendly cleaning product may be popular (and correspondingly highly rated by local consumers) in areas where a large portion of the population is particularly environmentally conscious. That same cleaning product may be far less popular (and correspondingly much lower rated by local consumers) in areas where the population is less environmentally conscious and/or more price-sensitive. Location-related data corresponding to the cleaning product's review and rating information may allow retailers to plan regional inventory in accordance with the region-specific variation in popularity. Furthermore, suppliers (e.g., manufacturers, distributors) of the product may also use the location-related consumer rating and reviews information to determine ways to improve the product to enable sales to a larger audience.

At 320, the consumer may be presented (e.g., upon completion of the in-location review) with a screen requesting that the consumer consider providing more details at a later time. The request screen may provide (element 322) a reference, such as a QR code that may be read by a mobile device. Alternatively or additionally, at 325 a request screen may be presented along with a provided (element 327) printout containing reference that provides an identifier, such as a network address (URL), of a content continuation submission page where the consumer can continue and/or complete their review of the product. Request screens 320 and 325 may in some cases display the URL of the content submission page. In yet another embodiment, the consumer may be provided (element 330) with a reference that includes a URL for the content continuation submission page and/or a QR code. The QR code may be associated with a particular reviewer ID which, in turn, is associated with the consumer's stored rating and information.

Continuing with the example of FIG. 3, the consumer may continue and/or complete the review submission (elements 335 and 340) at a later, more convenient time and/or place via an Internet-enabled device, such as desktop computer (see element 335) or mobile device (see element 340). This content continuation submission may be accomplished using a browser application through which client software 114 may provide interactive user interface 112. The consumer may access (e.g., using the reference described above) the content continuation submission page, and in response server 130 may operate to search data store 125 to locate the corresponding stored rating and review information. Server 130 may then operate to cause presentation of the content continuation submission page to the consumer. In some embodiments, the presented content continuation page may be pre-populated with information that was entered by the consumer during the initial in-store rating and review session, and may prompt the consumer to answer a more in-depth set of question relating to the reviewed product, and/or to otherwise provide more detailed information regarding the consumer's experience/opinion regarding the product. Various embodiments may protect consumer privacy by discouraging consumers from entering personal information in a review, or even go so far as to include procedures to screen submissions to ensure that private data that may be entered by a consumer is not processed.

Some embodiments of the present disclosure may include verification techniques for screening submissions in order to curb fraudulent reviews. Various authenticity screening rules may be used. For example, server 130 may detect that a particular in-store data collection device has been used to submit multiple reviews for the same product within an unusually short period of time (e.g., the number of submissions for the particular product received from a particular location within a time period may exceed a threshold). Such activity may be indicative of a particular consumer attempting to skew perception of a particular product by repeatedly entering high or low ratings for the product. For example, a particular consumer having a strong loyalty to a competitor's offering that competes with a particular product may attempt to negatively skew opinion of the particular product in an effort to drive perception of the competitor's offering as being more attractive. In this example, the particular consumer may enter multiple “one star” ratings of the particular product at a particular in-store device within a short period of time. In such cases, some or all of the multiple reviews may be flagged as candidates for possible exclusion from further processing. Thus, in some cases content continuation submission opportunities may limited to only a subset of multiple received in-store initial submissions that relate to a particular product (e.g., further processing may be limited to continuation of only the first of a set of initial submissions that relate to a particular product and were received within a particular time period). In some cases in which the verification techniques indicate that the submission pattern appears to be particularly egregious, all content continuation submission opportunities that correspond to the set of multiple received in-store initial submissions for the particular product may be excluded.

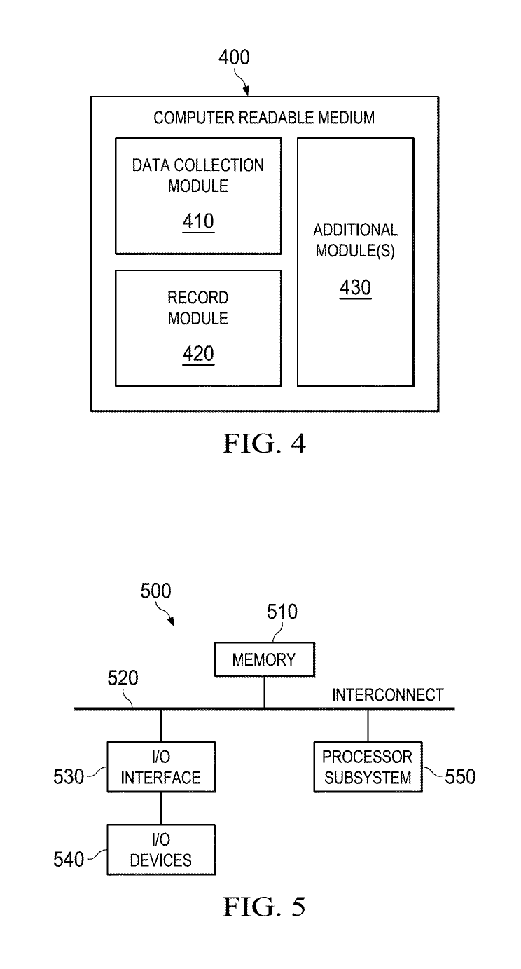

Turning now to FIG. 4, computer readable storage medium 400 is shown. In various embodiments, any or all of the modules (or a portion thereof) in medium 400 can be present in any computer system or computing device described herein (e.g., such as device 110, server 130, desktop computer described with respect to element 335, mobile device described with respect to element 340). As shown, computer readable storage medium 400 includes a data collection module 410 and a record module 420. In some embodiments, one or more additional modules 430 may also be present, which may be executed to cause one or more additional steps to be performed. In general, any steps, details, characteristics, or features described relative to method 200, process 300, and/or computer readable medium 400 may be suitably combined as consistent with this disclosure in various embodiments.

As shown, module 410 includes instructions that are executable to cause a computer system to collect user-generated content relating to an opinion of a product. This collecting of data may, in various embodiments, include any or all features of step 205 of method 100 and/or all features of steps 310 of process 300. In one embodiment, module 410 is configured to collect data by causing a computer system to receive the data from another computer system (that is, the term “collecting data” does not imply that data cannot be acquired from another source).

Module 420 includes instructions that are executable, in the embodiment of FIG. 4 to cause a computer system to cause a record corresponding to the collected user-generated content to be stored. In some embodiments, module 420 may additionally or alternately include instructions that are executable to cause a record to be modified (e.g., in response to a received request to update the record in accordance with additional collected information).

In one embodiment, module 430 includes instructions executable to cause a computer system to process (e.g., receive, collect) a request to modify a record. In some embodiments, module 430 may include instructions executable to cause a computer system to provide a reference that is usable to provide access by a different computer system to modify the record corresponding to the received user-generated content. In some embodiments, module 430 may include instructions that are executable to determining whether content satisfies an authenticity screening rule.

Turning now to FIG. 5, one embodiment of an exemplary computer system 500 is depicted. Computer system 500 includes a processor subsystem 550 that is coupled to a system memory 510 and I/O interfaces(s) 530 via an interconnect 520 (e.g., a system bus). I/O interface(s) 530 are coupled to one or more I/O devices 540. Computer system 500 may be any of various types of devices, including, but not limited to, a server system, personal computer system, desktop computer, laptop or notebook computer, mainframe computer system, handheld computer, workstation, network computer, or a device such as a mobile phone, pager, or personal data assistant (PDA). Computer system 500 may also be any type of networked peripheral device such as storage devices, switches, modems, routers, etc. Although a single computer system 500 is shown for convenience, the system may also be implemented as two or more computer systems operating together.

Processor subsystem 550 may include one or more processors or processing units. In various embodiments of computer system 500, multiple instances of the processor subsystem may be coupled to interconnect 520. In various embodiments, processor subsystem 550 (or each processor unit within the subsystem) may contain a cache or other form of on-board memory. In one embodiment, processor subsystem 550 may include one or more processors.

System memory 510 is usable by processor subsystem 550. System memory 510 may be implemented using different physical memory media, such as hard disk storage, floppy disk storage, removable disk storage, flash memory, random access memory (RAM-SRAM, EDO RAM, SDRAM, DDR SDRAM, RDRAM, etc.), read only memory (PROM, EEPROM, etc.), and so on. Memory in computer system 500 is not limited to primary storage. Rather, computer system 500 may also include other forms of storage such as cache memory in processor subsystem 550 and secondary storage on the I/O Devices 540 (e.g., a hard drive, storage array, etc.). In some embodiments, these other forms of storage may also store program instructions executable by processor subsystem 550.

I/O interfaces 530 may be any of various types of interfaces configured to couple to and communicate with other devices, according to various embodiments. In one embodiment, I/O interface 530 is a bridge chip (e.g., Southbridge) from a front-side to one or more back-side buses. I/O interfaces 530 may be coupled to one or more I/O devices 540 via one or more corresponding buses or other interfaces. Examples of I/O devices 540 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 500 is coupled to a network via a network interface device. The network interface device may be a wireless interface in various embodiments. In other embodiments, computer system 500 is part of a cloud-based computing service. In general, the present disclosure is not limited to any particular type of computer architecture.

### Exemplary Embodiments

In one embodiment, a method comprises receiving user-generated content at a first computer system. The computer system by be located at a point of sale of a product. The user-generated content may relate to an opinion of the product. The method may further comprise the first computer system causing a record corresponding to the received user-generated content to be stored. Furthermore, the method may include the first computer system providing data that is usable to provide access by a second computer system to modify the record corresponding to the received user-generated content.

In some embodiments, the causing of the record corresponding to the received user-generated content to be stored is performed based on determining that the received user-generated content satisfies an authenticity screening rule. In some cases, satisfying the authenticity screening rule requires that a number of submissions of user-generated content, received at a particular location and relating to the product, does not exceed a predetermined or dynamically determined threshold. In some cases, the particular location may include the first computer system. In some embodiments, the particular location may further include one or more other computer systems that are located at the point of sale of the product.

In some embodiments, the providing of the data that is usable to provide access to modify the record includes providing a reference that is usable to cause the second computer system to access an interface that is configured to submit second information. In some cases, the reference may be a machine-readable optical representation.

In some embodiments, the providing of the data that is usable to provide access to modify the record includes sending an electronic message comprising a reference that is usable to cause the second computer system to access an interface configured to submit second information. In some cases, the reference may be a Uniform Resource Locator.

In one embodiment, a computer-readable storage medium may store instructions that are executable by a first computer system to cause the first computer system to perform operations that include receiving user-generated content relating to an opinion of a product. The user-generated content may be received at a point of sale of a product. The operations may also include determining whether the received user-generated content satisfies an authenticity screening rule. Furthermore, the operations may cause a record corresponding to the received user-generated content to be stored in response to determining that the authenticity screening rule is satisfied. The operations may also include the providing of data usable to provide access by a second computer system to modify the record that corresponds to the received user-generated content.

In some embodiments, the causing the record corresponding to the received user-generated content to be stored may include storing first content. In some cases, the modifying the record that corresponds to the received user-generated content may include adding second content to the first content. In certain embodiments, the first content includes a rating of the product and the second content includes a review relating to the product.

In some embodiments, the causing the record to be stored includes storing particular content. In some cases, the modifying the record includes modifying the particular content.

In various embodiments, the providing the data usable to provide access includes sending an electronic message. The electronic message may include a reference that is usable to cause the second computer system to access an interface configured to submit second information. The electronic message in some cases may be an electronic mail message (e.g., email message). In some cases, the electronic message may be a text message (e.g., SMS message). In some cases, the electronic message may be sent to a device running a particular application, and may be presented as a notification within the particular application (e.g., a notification presented by a retailer-specific smartphone application). In various cases, the sending of the electronic message may be initiated by a sender (e.g., pushed by as server), and/or may be initiated by the recipient (e.g., pulled by a client).

In one embodiment, a system may include a first computer system that is located at the point of sale of a product, and a second computer system that is located at a different location. The first computer system may be configured to receive user-generated content relating to an opinion of the product. The first computer system may be further configured to provide a reference that is usable to provide access by a different computer system to modify the record corresponding to the received user-generated content.

The second computer system may be configured to store a record corresponding to the received user-generated content and to receive a request to modify the record, where the request corresponds to the provided reference. The second computer may be further configured to send data to a third computer system in response to receiving the request to modify the record. The sent data may be configured to cause the third computer system to provide an interface that is usable to submit second information from the third computer system. The second computer may additionally be configured to receive the second information, and to modify the record based on the received second information.

In some embodiments, the system may be configured to exclude storage of user-generated content that fails to satisfy an authenticity screening rule. In some cases, satisfying the authenticity screening rule requires that a number of submissions of user-generated content that is received at the first computer system during a time period and that relates to the product does not exceed a threshold. In some cases, satisfying the authenticity screening rule requires that a number of submissions of user-generated content that is received at a plurality of computer systems during a time period and that relates to the product does not exceed a threshold.

Although the present methods, systems, and techniques have been described with respect to specific embodiments thereof, these embodiments are merely illustrative, and not restrictive. The description herein of the illustrated embodiments is not intended to be exhaustive or to be limited to the precise forms disclosed herein. Rather, the description is intended to describe illustrative embodiments, features, and functions in order to provide a person of ordinary skill in the art context to understand the present methods, systems, and techniques without limiting the scope to any particularly described embodiment. Descriptions of known programming techniques, computer software, hardware, operating platforms and protocols may be omitted so as not to unnecessarily obscure the disclosure in detail. Various substitutions, modifications, additions and/or rearrangements within the spirit and/or scope of the underlying inventive concept will become apparent to those skilled in the art from this disclosure.

Embodiments discussed herein can be implemented in one or more computers communicatively connected to a network (for example, the Internet) and/or in one or more standalone computers. As is known to those skilled in the art, an exemplary computer can include a central processing unit (“CPU”), at least one read-only memory (“ROM”), at least one random access memory (“RAM”), and/or one or more input/output (“I/O”) device(s). The I/O devices can include a keyboard, monitor, printer, electronic pointing device (for example, mouse, trackball, stylist, touch pad, etc.), or the like. Some embodiments may include one or more hard drive (“HD”). In some embodiments, the computer has access to at least one database over a network connection.

ROM, RAM, and HD are computer memories for storing computer-executable instructions executable by the computer system (e.g., using the CPU) or capable of being complied or interpreted to be executable by the computer system. Suitable computer-executable instructions may reside on a computer readable medium (e.g., ROM, RAM, and/or HD), hardware circuitry or the like, or any combination thereof.

The processes described herein may be implemented using suitable computer-executable instructions, which may reside on a computer readable medium (for example, a disk, CD-ROM, a memory, etc.). Alternatively, the computer-executable instructions may be stored as software code components on a direct access storage device array, network-based access storage device, magnetic tape, floppy diskette, optical storage device, or other appropriate computer-readable medium or storage device.

Any suitable programming language can be used to implement the routines, methods or programs that may correspond to various ones of the embodiments described herein. For example, C, C++, Java, JavaScript, HTML, and/or any other programming or scripting language, etc. may be used. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

In various embodiments, different programming techniques can be employed, such as procedural or object-oriented techniques. Any particular routine can execute on a single computer processing device, multiple computer processing devices, a single computer processor, and/or multiple computer processors. Data may be stored in a single storage medium and/or may be distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the disclosed techniques.

It is also within the spirit and scope of the present disclosure to implement in software programming or code an of the steps, operations, methods, routines or portions thereof described herein, where such software programming or code can be stored in a computer-readable medium and can be operated on by computer (e.g., using a processor) to permit the computer to perform any of the steps, operations, methods, routines or portions thereof described herein. The disclosed techniques may be implemented by using software code executing at least in part in one or more general purpose digital computers, and/or by using application specific integrated circuits, programmable logic devices, field programmable gate arrays, optical, chemical, quantum or nanoengineered systems, components and mechanisms. In general, the functions of the invention can be achieved by any means as is known in the art. For example, distributed or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and may include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by a computing system using one or more processors.

A “processor” includes any hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, process, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the accompanying drawings, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein and in the accompanying drawings, the meaning of “in” includes “in” and “on” unless the context clearly dictates otherwise.

It will also be appreciated that one or more of the elements depicted in the accompanying drawings can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

1. A method, comprising:
receiving, at a first computer system located at a point of sale, a submission by a user of first content relating to an opinion of a product;
causing, by the first computer system, the first content to be stored at a data repository; and
providing to the user, by the first computer system, data usable by the user to allow submission, at a subsequent time, of second content relating to the opinion of the product.

2. The method of claim 1, wherein causing the first content to be stored at the data repository is performed based on determining that the received first content satisfies an authenticity screening rule.

3. The method of claim 2, wherein determining that the received first content satisfies the authenticity screening rule includes determining that a number of submissions of first content received at a particular location and relating to the product does not exceed a threshold.

4. The method of claim 3, wherein the particular location includes the first computer system.

5. The method of claim 1, wherein the second content includes an edited version of the first content.

6. The method of claim 1, wherein providing the data usable to allow the submission of the second content includes providing a reference that is usable to access an interface that is configured to receive the second content.

7. The method of claim 6, wherein the reference is a machine-readable reference.

8. The method of claim 1, wherein providing the data usable to allow the submission of the second content includes sending an electronic message comprising a reference that is usable to cause a second computer system to access an interface that is configured to receive the second content.

9. The method of claim 1, wherein the data repository is located at a different geographical location than the first computer system.

10. A non-transitory, computer-readable medium having stored thereon instructions that are executable by a first computer system at a point of sale to cause the first computer system to perform operations comprising:
receiving, from a user, a submission of first content relating to an opinion of a product;
causing the first content to be stored; and
providing to the user data usable to allow a submission of second content at a subsequent time.

11. The non-transitory, computer-readable medium of claim 10, wherein the submission of the second content causes the second content to be added to the first content.

12. The non-transitory, computer-readable medium of claim 10,
wherein the first content includes a rating of a product; and
wherein the second content includes a review relating to the product.

13. The non-transitory, computer-readable medium of claim 10, wherein the operations further comprise determining whether the first content satisfies an authenticity screening rule.

14. The non-transitory, computer-readable medium of claim 10, wherein providing the data usable to allow the submission of the second content includes sending an electronic message comprising a reference that is usable to access an interface that is configured to receive the second content.

15. The non-transitory, computer-readable medium of claim 14, wherein the electronic message is an electronic mail message.

16. The non-transitory, computer-readable medium of claim 14, wherein the electronic message is a text message.

17. A system, comprising:
a first computer system located at a point of sale configured to:
receive, from a user, user-generated content relating to an opinion of a product; and
provide a reference to the user; and
a second computer system configured to:
store a record corresponding to the user-generated content received by the first computer;
receive a request from the user to modify the record, wherein the request corresponds to the provided reference; and
modify the record based on the received request.

18. The system of claim 17, wherein the reference is a Uniform Resource Locator (URL).

19. The system of claim 17, wherein the request to modify the record is a request to add additional user-generated content to the record.

20. The system of claim 17, wherein the second computer system is disposed at a different geographical location than the point of sale.
